(19) United States
(12) Patent Application Publication
(10) Pub. No.: US 2026/0115723 A1
(43) Pub. Date: Apr. 30, 2026

(54) FLUIDIC CARTRIDGE WITH A FLUIDIC CHAMBER

(71) Applicant: SEFUNDA AG, Muttenz (CH)

(72) Inventors: Robert E. SCHNEIDER, Longmont, CO (US); Ben SETTERQUIST, Boulder, CO (US); Anne COX, Longmont, CO (US); Philip SCHREIBER, Boulder, CO (US); Mackenzie AMIDEI, Arvada, CO (US); Scott SCHMIDT, Aurora, CO (US); Mark MAYERNICK, Lafayette, CO (US); James HUTCHISON, Denver, CO (US); Tom VINCENT, Fort Collins, CO (US); Laurin DIENER, Zürich (CH); Anna Katharina ELMER, Lörrach (DE); Marion GILSDORF, Nusshof (CH); Serej D. LEY, Basel (CH); Melanie SCHÄPERS, Lörrach (DE); Jacob BÖROLD, Zürich (CH)

(21) Appl. No.: 19/164,790

(22) PCT Filed: Mar. 8, 2024
(86) PCT No.: PCT/EP2024/056227

§ 371 Date: Sep. 12, 2025

Related U.S. Application Data
(60) Provisional application No. 63/451,797, filed on Mar. 13, 2023.

(30) Foreign Application Priority Data
Apr. 27, 2023 (EP) 23170326.5

(51) Int. Cl. B01L 3/00; G01L 15/00

(52) U.S. Cl. CPC B01L 3/502761; B01L 3/50273; G01L 15/00; B01L 2200/04; B01L 2200/0668; B01L 2200/16; B01L 2300/0681; B01L 2300/087; B01L 2400/0487

(57) ABSTRACT

A fluidic cartridge is provided, comprising: a fluidic chamber including a first fluidic compartment and a semipermeable membrane separating the first fluidic compartment from a second fluidic compartment, wherein the semipermeable membrane is non-permeable for liquid and permeable for air, and wherein the second fluidic compartment is a closed compartment configured for accumulating air, and a pumping device configured for pumping a liquid into the first fluidic compartment such that the first fluidic compartment is filled with the liquid, whereby air contained in the first fluidic compartment is forced through the semipermeable membrane into the second fluidic compartment and accumulates in the second fluidic compartment such that a pressure within the second fluidic compartment increases, and a fluidic discharge line coupled to the first fluidic compartment and configured for discharging the first fluidic compartment using the pressure within the second fluidic compartment.

### CROSS-REFERENCE TO RELATED APPLICATION

This application is a Section 371 National Stage Application of International Application No. PCT/EP2024/056227, filed on Mar. 8, 2024, entitled “FLUIDIC CARTRIDGE WITH A FLUIDIC CHAMBER”, and published as WO 2024/188880 A1 on Sep. 19, 2024, which claims priority to European Patent Application No. EP 23170326.5, filed on Apr. 27, 2023, and which claims priority to United States Provisional Ser. No. 63/451,797 filed on Mar. 13, 2023, the contents of which are incorporated herein by reference in their entireties.

The present invention relates to a fluidic cartridge. In particular, the present invention relates to a fluidic cartridge which can be used for testing and/or analyzing samples such as biological samples.

Sample testing and analyzing is a discipline that has developed rapidly during the last years and decades. It originated from basic biochemistry and molecular biology research procedures, but since then has evolved into a discipline focused on routine analysis and high-throughput testing.

One of many approaches which have helped in this transformation is the use of fluidic cartridges. Fluidic cartridges are self-contained components which—in combination with other modules and/or units—facilitate the testing and analysis of samples (such as blood, urine, saliva and other samples). Usually, the sample is put onto the fluidic cartridge. The sample is then moved within the cartridge through various sites of the cartridge to perform different actions on the sample, such as cleaning/washing of the sample, extraction of deoxyribonucleic or ribonucleic acid (DNA, RNA) and/or performing a polymerase chain reaction (PCR).

For some of these actions, defined volumes of liquid are necessary. Defined volumes may be necessary in order to isolate a certain amount of liquid. Defined volumes may also be necessary in order to extract a certain amount of liquid which may then be used in a certain reaction and/or processing step. Typically, volumetric flowrate sensors are used to determine defined volumes of liquid. Additionally or alternatively, high-precision pumps could be used for metering defined volumes of liquid based on a delivery volume of the pump. It has been found, however, that using volumetric flowrate sensors and/or high-precision pumps in a fluidic cartridge is expensive and complicated. Thus, there is a need to provide an improved fluidic cartridge. Furthermore, there is a need to provide a method of operating such a fluidic cartridge.

These tasks are solved by the subject-matters of the independent claims. Further embodiments and developments are provided in the dependent claims.

According to a first aspect of the present invention, a fluidic cartridge is provided. The fluidic cartridge comprises a fluidic chamber including a first fluidic compartment, and a semipermeable membrane. The semipermeable membrane separates the first fluidic compartment from a second fluidic compartment of the fluidic chamber and/or it closes the first fluidic compartment against an environment of the fluidic cartridge. The semipermeable membrane is non-permeable for liquid and permeable for air. The semipermeable membrane may be non-permeable for polar and/or non-polar liquids, as the case may be. The fluidic cartridge further comprises a pumping device configured for pumping a liquid into the first fluidic compartment such that the first fluidic compartment is filled with the liquid, whereby air contained in the first fluidic compartment is forced through the semipermeable membrane into the second fluidic compartment and/or into the environment.

The fluidic cartridge is based at least partially on the idea that defined volumes of liquid may be provided using a fluidic chamber with two fluidic compartments that are separated by a semipermeable membrane which is non-permeable for liquid and permeable for air. Once liquid is pumped into the first fluidic compartment the first fluidic compartment is filled with the liquid and air contained in the first fluidic compartment is forced through the semipermeable membrane into the second fluidic compartment. This way the first fluidic compartment is filled with liquid only. None or little air is present in the first fluidic compartment. As a result, a defined volume of liquid is provided within the first fluidic compartment. This defined volume of liquid can then be isolated and/or used for further processing within the cartridge. The fluidic cartridge according to the present invention thus offers an alternative approach to using volumetric flowrate sensors and/or high-precision pumps.

Optionally, the first fluidic compartment includes a first volume. Optionally, the first volume is a predetermined volume. Optionally, the first volume may be adjusted to the application at hand and/or may depend on the volume of liquid which needs to be isolated and/or used for further processing.

Optionally, the second fluidic compartment is a closed compartment. Optionally, the second fluidic compartment is a closed compartment configured for accumulating air. This preferred configuration is at least partially based on the idea that air forced through the semipermeable membrane into the second fluidic compartment cannot exit the second fluidic compartment. As a result, air accumulates in the second fluidic compartment, gets compressed in the second fluidic compartment and a pressure within the second fluidic compartment increases. This pressure may be used for discharging the liquid contained in the first fluidic compartment. As such, the cartridge may be configured such that no further and/or separate components or means such as pumps or the like are necessary for discharging the liquid from the first fluidic compartment.

Optionally, the second fluidic compartment is arranged on top of the first fluidic compartment. In particular the second fluidic compartment may be arranged directly on top of the first fluidic compartment. More optionally, the semipermeable membrane may close a top opening of the first fluidic compartment and/or may close a bottom opening of the second fluidic compartment. In other words, the semipermeable membrane may form a semipermeable partitioning between first and second fluidic compartment. Optionally, the first fluidic compartment and the second fluidic compartment may be formed in separate members of the cartridge and the semipermeable membrane may be arranged in-between these separate members. Optionally, these separate members may be arranged on top of each other such that that the first and second fluidic compartments are arranged on top of each other separated only by the semipermeable membrane.

Optionally, the fluidic cartridge further comprises a pressure sensor configured for sensing pressure in the first fluidic compartment and/or in the second fluidic compartment.

Optionally, the fluidic cartridge and/or an apparatus into which the fluidic cartridge is configured to be inserted further comprises a control unit configured for controlling the pumping device into an inactive state and/or not actuate the pump when the pressure sensed by the pressure sensor approaches a predetermined threshold pressure, and/or when a pressure signal provided by the pressure sensor reaches a substantially constant value, and/or wherein a rate of change of a pressure signal provided by the pressure sensor reaches a predetermined threshold value. This preferred configuration is at least partially based on the idea that when the liquid front of the liquid reaches the semipermeable membrane, the liquid is hindered from passing the semipermeable membrane. Since the liquid is incompressible, at least in comparison to air, the pressure will increase and approach a predetermined threshold pressure, and/or a rate of change of the pressure may suddenly change and/or reach a predetermined threshold value, and/or the pressure may reach a plateau which could be detected by the pressure signal approaching a substantially constant value. The predetermined threshold pressure may be, e.g. equal to or below a breakthrough pressure of the semipermeable membrane. By the word “breakthrough pressure” a pressure required for the liquid to pass through pores of the semipermeable membrane is meant.

Optionally, the fluidic cartridge further comprises a fluidic supply line coupled to the first fluidic compartment and configured for supplying the liquid to the first fluidic compartment.

Optionally, an inlet valve is located in the fluidic supply line. The inlet valve may be operable between an open state and a closed state. The control unit may be configured for controlling the open and closed state of the inlet valve. The fluid supply line may be configured to supply fluid into the first fluid compartment from below. The fluid supply line may be configured to supply fluid into the first fluid compartment from the bottom or a bottom portion of said first fluidic compartment.

Optionally, the fluidic cartridge may further comprise a fluidic discharge line coupled to the first fluidic compartment and configured for discharging the first fluidic compartment.

Optionally, an outlet valve is located in the fluidic discharge line. The outlet valve may be operable between an open state and a closed state The control unit may be configured for controlling the open and closed state of the outlet valve. The fluid discharge line may be configured to discharge fluid from the first fluid compartment from the bottom or a bottom portion of said first fluidic compartment.

Optionally, the pressure sensor is configured for sensing a pressure inside the first or the second fluidic compartment. The pressure sensor may be located in the fluidic supply line or the fluidic discharge line. Alternatively, the pressure sensor may be provided in the first fluidic compartment or the second fluidic compartment.

Optionally the fluidic cartridge further comprises a reagent configured to be reconstituted. The reagent may be a lyophilized reagent, more optionally a lyophilized bead. The reagent may be located in the first fluidic compartment and may be configured for being reconstituted by the defined volume of liquid in the first fluidic compartment. This way a liquid with a defined final concentration can be obtained.

Optionally, the first fluidic compartment has a conical shape and/or a funnel like shape and/or a tapered shape. Optionally, a diameter and/or a width of the first fluidic compartment increases towards the semipermeable membrane. In other words, the first fluidic compartment may have a shape, wherein a diameter and/or a width of the first fluidic compartment decreases with increasing distance from the semipermeable membrane. This configuration ensures that substantially all liquid contained in the first fluidic compartment can be discharged from the first fluidic compartment and/or prevents any air bubbles from being trapped inside the first fluidic compartment.

In a second aspect of the present invention, a method of transferring liquid into and/or out of a fluidic chamber of a fluidic cartridge is provided. The fluidic chamber includes a first fluidic compartment and a semipermeable membrane. The semipermeable membrane separates the first fluidic compartment from a second fluidic compartment of the fluidic chamber and/or it closes the first fluidic compartment against an environment of the fluidic cartridge. The semipermeable membrane is non-permeable for liquid and permeable for air. The method comprises the step of operating a pumping device such that the first fluidic compartment is filled with a liquid, whereby air contained in the first fluidic compartment is forced through the semipermeable membrane into the second fluidic compartment and/or into the environment.

The method is based at least partially on the idea that by operating a pumping device such that the first fluidic compartment is filled with liquid whereby air is forced through the semipermeable membrane, a defined volume of liquid is provided in the first fluidic compartment. With such a method a defined volume of liquid can be measured and/or provided in a fluidic cartridge which is an alternative to using volumetric flow rate sensors and/or high-precision pumps.

Optionally, the method further comprises the step of continuing operation of the pumping device such that the air forced through the semipermeable membrane is compressed in the second fluidic compartment.

Optionally, operating the pumping device is stopped, when a number of strokes performed by the pumping device exceeds a predetermined threshold number, and/or when a pressure sensed within the first and/or the second fluidic compartment approaches a predetermined threshold pressure, and/or when a pressure signal provided by the pressure sensor reaches a substantially constant value. The predetermined threshold pressure may be equal to or below a breakthrough pressure of the semipermeable membrane.

Optionally, the method further comprises the steps of operating the pumping device while an inlet valve located in a fluidic supply line coupled with the first fluidic compartment is in an open state and an outlet valve located in a fluidic discharge line coupled to the first fluidic compartment is in a closed state, stop operating the pumping device when the pressure sensed within the first and/or second fluidic compartment approaches the predetermined threshold pressure and/or when the pressure signal provided by the pressure sensor reaches a substantially constant value, closing the inlet valve such that the fluidic supply line is closed, and opening the outlet valve, e.g. such that the first fluidic compartment is emptied by the pressure in the second fluidic compartment.

Preferred embodiments of the first aspect may be preferred embodiments of the second aspect, and vice versa. In other words, the fluidic cartridge according to the first aspect may be used in the method according to the second aspect described herein.

In a third aspect, the present invention relates to a system comprising a fluidic cartridge according to the first aspect and an apparatus in which said fluidic cartridge is received and/or inserted. The apparatus may be configured to actuate the pumping device of the fluidic cartridge and/or to receive a pressure signal from the pressure sensor of the fluidic cartridge. The system may be configured for performing (e.g., automatically) the method according to the second aspect when the fluidic cartridge is received in the apparatus.

Further embodiments and aspects of the present invention are explained using the accompanying schematic figures, which are incorporated herein and constitute a part of the specification. These figures are merely exemplary. They are not to be understood as limiting the scope of the present disclosure.

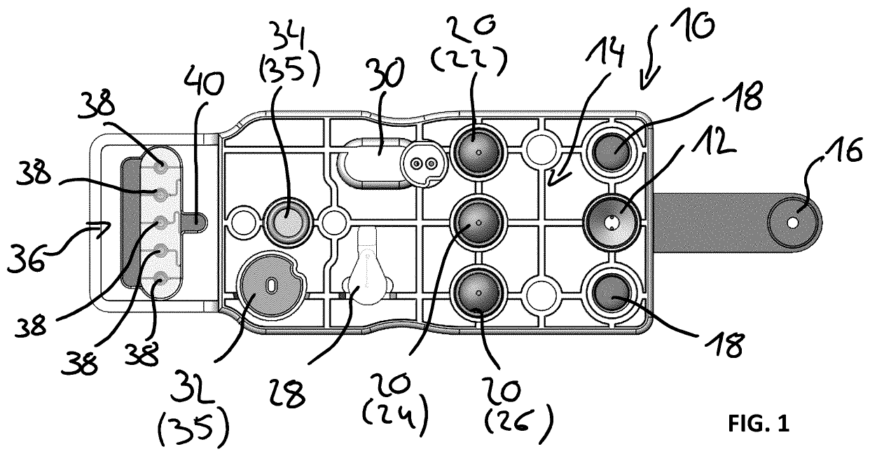

FIG. 1 is a top view of an exemplary fluidic cartridge in which the invention may be provided.

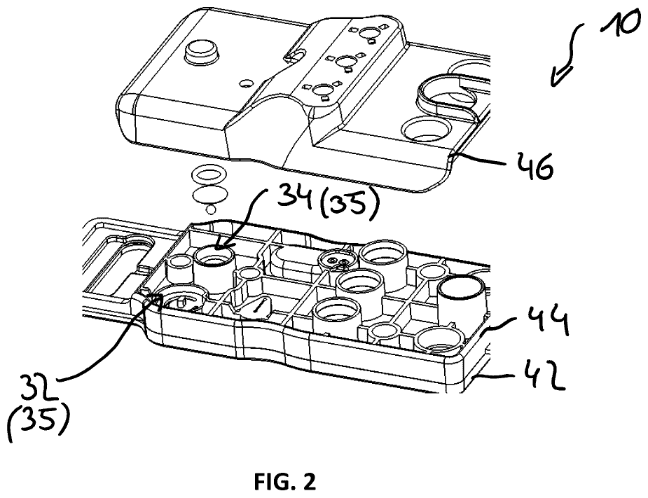

FIG. 2 is an exploded view of the fluidic cartridge of FIG. 1.

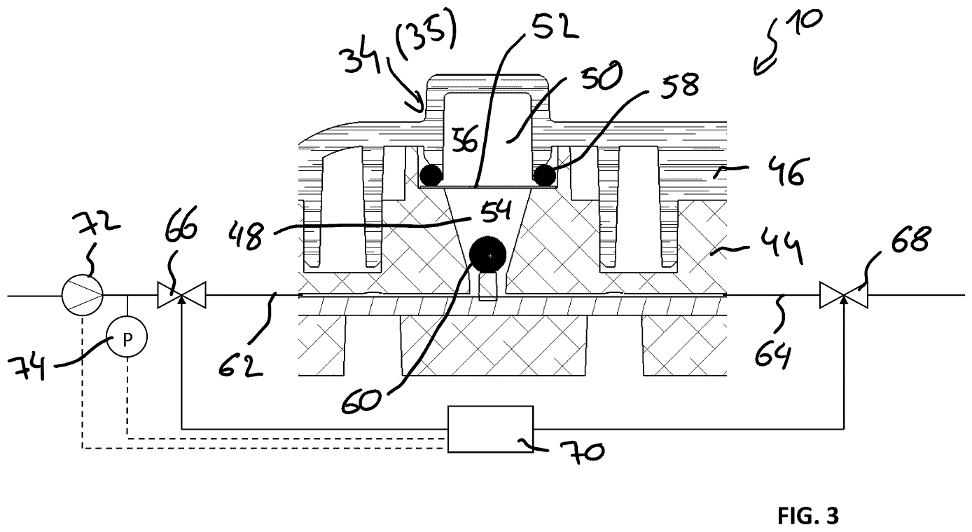

FIG. 3 is a schematic section view of one example of a fluidic chamber provided in the fluidic cartridge of FIG. 1.

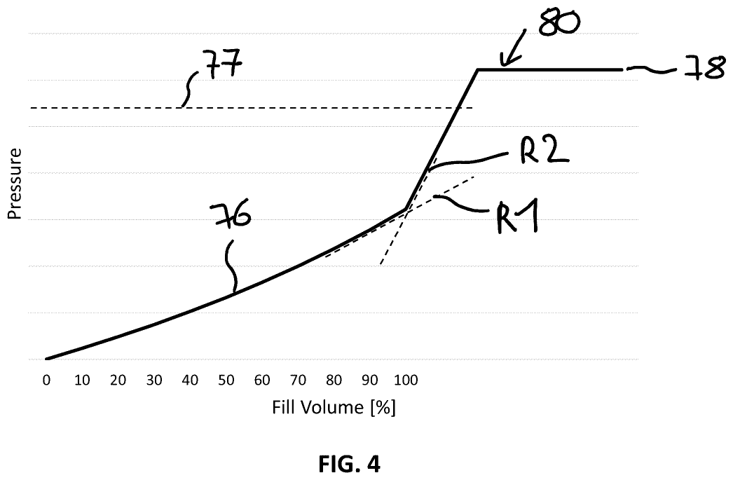

FIG. 4 is a schematic diagram of a pressure signal obtained within the fluidic chamber of FIG. 3 during filling of the same.

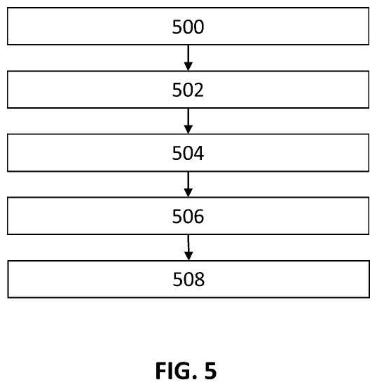

FIG. 5 is a flowchart of processing steps for transferring liquid into and/or out of the fluidic chamber of FIG. 3.

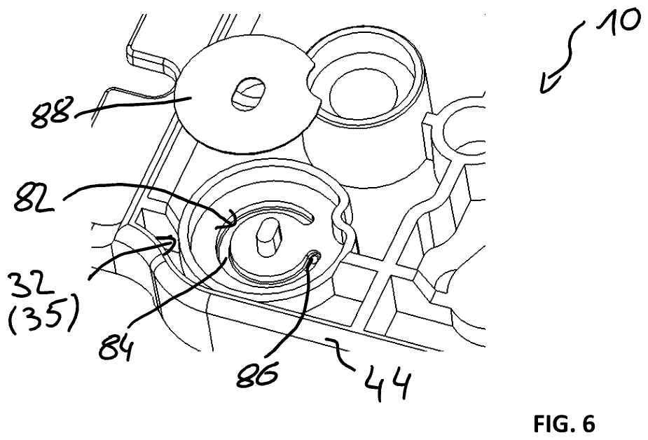

FIG. 6 is an exploded detailed view of another example of a fluidic chamber provided in the fluidic cartridge of FIG. 1.

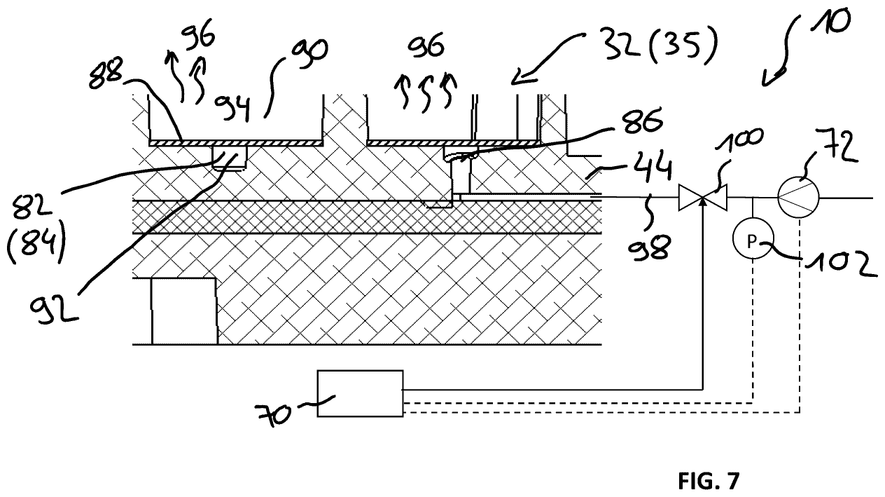

FIG. 7 is a schematic section view of the fluidic chamber of FIG. 6.

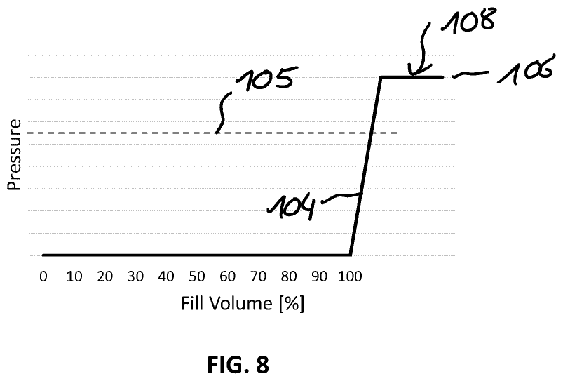

FIG. 8 is a schematic diagram of a pressure signal obtained within the fluidic chamber of FIG. 6 during filling of the same.

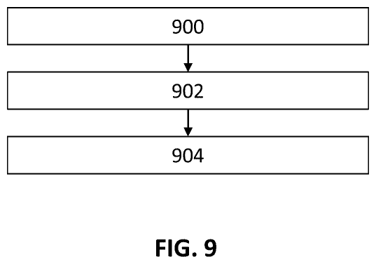

FIG. 9 is a flowchart of processing steps for transferring liquid into and/or out of the fluidic chamber of FIG. 6.

Within the figures, same components are referenced by the same reference numerals.

Embodiments of the invention will now be described in context with an exemplary fluidic cartridge in which the invention is implemented.

FIG. 1 shows a top view of an exemplary fluidic cartridge 10. Exemplary fluidic cartridge 10 chosen to illustrate the present invention is used for the detection of Chlamydia trachomatis bacterium and/or Neisseria gonorrhoeae bacterium. The person skilled in the art would understand, however, that fluidic cartridge 10 can be used for various other applications using other sample analysis and/or other tests. For example, the fluidic cartridge 10 may be used in any test for amplifying genetic material, such as DNA and/or RNA amplification. The fluidic cartridge 10 may be used, e.g., in polymerase chain reaction (PCR), ligase chain reaction (LCR), transcription-mediated amplification (TMA), loop-mediated isothermal amplification (LAMP), or any other technique making use of a fluidic cartridge.

Fluidic cartridge 10 is predominantly made of plastic material. By the word plastic is meant an organic material which can be shaped when soft and hardened after shaping. Fluidic cartridge 10 is made of a moldable plastic material, more precisely of an injection-moldable plastic material. Exemplary materials can be, for example, polyethylene, polypropylene or polycarbonate. The person skilled in the art would understand, however, that other suitable materials can be used as well.

Fluidic cartridge 10 is intended to be a single-use, disposable cartridge. Fluidic cartridge 10 is intended to be used for performing tests on a sample, especially a liquid sample, introduced into the cartridge 10. Fluidic cartridge 10 is a multiplexed cartridge and primarily intended to be used for point of care testing using, for example, PCR amplification of certain target nucleic acid(s) such as DNA or RNA.

Fluidic cartridge 10 includes a sample entry port 12 configured for receiving a sample. By sample is meant the composition which is introduced into the cartridge 10 to perform the required test(s) or analysis. More precisely, by sample is meant the composition in which it is determined whether the target nucleic acid(s) of interest is/are present. The sample may in particular be a liquid sample. The sample can have a variety of sources such as blood, urine, saliva, swab eluate or other sources. The sample can be pretreated prior to being introduced into cartridge 10. The preferred use of fluidic cartridge 10 is, however, the use of a sample which has not been pretreated prior to introduction into cartridge 10.

The sample is placed on sample entry port 12 from where the sample is introduced into a network 14 of fluidic pathways of cartridge 10. Sample entry port 12 can be closed by a sample cover 16. In the specific embodiment shown, sample cover 16 is bendable and flexible so that sample cover 16 can be bent over sample entry port 12 for closing sample entry port 12 once the sample has been placed on sample entry port 12. In other embodiments not shown, sample cover 16 may be any other appropriate sample cover. For example, sample cover 16 may be a screw cap which can be screwed onto sample entry port 12 for closing the same.

When the sample is introduced into cartridge 10 a variety of actions can be performed on the sample. Some of these actions are described further below.

The sample may be pumped through the fluidic network 14 of cartridge 10. Pumping of the sample, or more generally pumping of a liquid, is performed using diaphragm pumps 18. Diaphragm pumps 18 include a functional layer which is actuated, for example externally, so that a pumping force can be applied to the fluid inside the fluidic network 14. The design and the function of diaphragm pumps 18 is not the focus of this disclosure, which is why no further explanation is given herein.

Furthermore, to perform the necessary actions on the sample, additionally liquids may be required. These liquids need to be introduced into the cartridge 10 so that, for example, the sample may be mixed with these liquids and primed for further actions. Within fluidic cartridge 10, liquids are presented in so-called liquid containers 20. Liquid containers 20 are configured to contain liquid and expel the liquid into cartridge 10. The specific design of liquid containers 20 is, however, not the focus of this disclosure, which is why no further explanation is given herein.

As shown in FIG. 1, cartridge 10 includes three liquid containers 20. The person skilled in the art would understand, however, that in other embodiments fluidic cartridge 10 may include more or less than three containers 20.

A first container 22 includes a binding liquid, also called binding buffer. The binding buffer helps that a specific component of the sample, for example nucleic acid(s) of the sample, can be captured by a capture membrane. A second container 24 includes a wash liquid, also called wash buffer. The wash buffer is used to remove cell debris and/or other unwanted cellular components from the sample, and/or components that may inhibit the test reaction. A third container 26 includes an elution liquid, also called elution buffer. The elution buffer is used to elute nucleic acid(s) captured by the capture membrane.

The person skilled in the art would understand, however, that liquid containers 20 are not limited to containing binding buffer, wash buffer or eluate buffer. Liquid containers 20 may contain any suitable liquid.

Fluidic cartridge 10 further includes a capture membrane 28. Capture membrane 28 captures and binds specific nucleic acid(s) of interest but does not capture or bind other undesired cellular components such as proteins or lipids. The principle of binding nucleic acid(s) using a capture membrane is well known to a person skilled in the art which is why no further explanation is given herein. Capture membrane 28 may be made of glass fibers, silica or other suitable material(s).

Fluidic cartridge 10 further includes a waste chamber 30. Waste chamber 30 is fluidly connected to capture membrane 28. Waste chamber 30 is used for accommodating liquid(s) and/or liquid mixtures which are no longer used and/or no longer of interest. For example, waste chamber 30 may contain wash buffer which was used to wash capture membrane 28.

Fluidic cartridge 10 further includes a pre-wet chamber 32. Pre-wet chamber 32 is configured for accommodating fluids such as liquids and gaseous fluids such as air. Pre-wet chamber 32 is fluidly connected to capture membrane 28. Pre-wet chamber 32 can be used for pre-wetting capture membrane 28. Pre-wetting of capture membrane 28 allows residual liquid which is present inside pores of capture membrane 28 to be removed from the membrane 28 for priming the line. For example, after capture membrane 28 was washed with wash buffer and flushed with air, residual liquid may still be present inside pores of capture membrane 28. In the pre-wet step, capture membrane 28 may be flushed with elution buffer such that elution buffer can reach capture membrane 28 and push any remaining air and/or residual liquid into pre-wet chamber 32. Alternatively or additionally, in the pre-wet step the fluidic line up to capture membrane 28 may be primed for further action, e.g. by pushing any air contained therein into the pre-wet chamber 32.

Fluidic cartridge 10 further includes a homogenization chamber 34. Homogenization chamber 34 is configured for accommodating fluids such as liquids and gaseous fluids such as air. Homogenization chamber 34 is fluidly connected to capture membrane 28 downstream of capture membrane 28. Homogenization chamber 34 includes one or more lyophilized reagents. Once the homogenization chamber 34 is filled with a fixed amount of liquid, the lyophilized reagent is reconstituted resulting in a liquid having a defined final concentration. In the exemplary fluidic cartridge 10, liquid with nucleic acid(s) eluted from capture membrane 28 is fed into homogenization chamber 34. The nucleic acid(s) may be specific for Chlamydia trachomatis and/or Neisseria gonorrhoeae. The lyophilized reagent may include reagents, in particular PCR reagents such as polymerase, dNTPs and/or enhancers, which may be used in PCR test reactions, such as Chlamydia trachomatis and/or Neisseria gonorrhoeae test reactions. The PCR reagents may be unspecific to an analyte to be tested for.

In other words, when the homogenization chamber 34 is filled with liquid eluted from the capture membrane 28, the lyophilized reagent is reconstituted and a liquid with a desired final concentration is obtained which can then be used, for example, for PCR reaction tests.

Pre-wet chamber 32 and homogenization chamber 34 are examples of fluidic chambers 35 provided in fluidic cartridge 10. In fluidic cartridge 10, fluidic chambers 35 are used to either isolate defined volumes of liquid or to extract defined volumes of liquid for further processing. Pre-wet chamber 32 is one example of a fluidic chamber 35 that is used for isolating a defined volume of liquid. The design and function of pre-wet chamber 32 is explained in more detail in connection with FIGS. 6 to 9. Homogenization chamber 34 is an example of a fluidic chamber 35 that is used for extracting a defined volume of liquid which is used for further processing. The design and function of homogenization chamber 34 is explained in more detail in connection with FIGS. 3 to 5.

The person skilled in the art would understand, however, that fluidic cartridge 10 may include multiple fluidic chambers 35 in addition to or as an alternative to the above mentioned pre-wet chamber 32 and homogenization chamber 34.

Fluidic cartridge 10 further includes an analyte detection section 36. Analyte detection section 36 includes one or more detection chambers 38. Liquid provided by homogenization chamber 34 is distributed via a fluid inlet section 40 to the detection chambers 38. Inside detection chambers 38, a PCR reaction or any other suitable test reaction may take place. For example, in the exemplary fluidic cartridge 10, detection chambers 38 may include PCR primers specific for Chlamydia trachomatis and/or Neisseria gonorrhoeae such that Chlamydia trachomatis and/or Neisseria gonorrhoeae can be tested and/or detected. It will be understood that primers specific to any other analyte of interest may be provided.

In the exemplary fluidic cartridge 10, detection section 36 includes five detection chambers 38. A different primer may be provided in each section. The person skilled in the art would understand, however, that more or less than five detection chambers 38 may be present in detection section 36.

Fluidic cartridge 10 may include further components. For example, fluidic cartridge 10 may include one or more valve sections. Valve sections allow the blocking and/or opening of specific fluidic pathways between various components of the cartridge 10. Valve sections may be active valve sections or passive valve sections. By active valve section is meant that these valve sections are controlled actively, for example by an external actuator. By passive valve section is meant that these valve sections are not actively controlled. Passive valve sections are, for example, shut-off valves, check-valves, umbrella valves or other types of passive valves. In the exemplary fluidic cartridge 10, active valve sections are provided, for example, upstream and downstream of homogenization chamber 34. Passive valve sections are provided, for example, upstream or downstream of liquid containers 20.

Fluidic cartridge 10 may further include one or more pressure sensors configured for sensing a pressure inside a specific fluidic pathway of cartridge 10. In exemplary fluidic cartridge 10, pressure sensors are provided, for example, upstream of pre-wet chamber 32 and upstream of homogenization chamber 34.

In the following, exemplary actions performed on a sample that has been introduced into fluidic cartridge 10 are described.

Binding buffer is pumped from the first liquid container 22 into the sample entry port 12 using at least one of the diaphragm pumps 18.

The mixture of sample and binding buffer is pumped and/or drawn through the capture membrane 28 and into the waste chamber 30 using at least one of the diaphragm pumps 18.

Wash buffer is pumped from the second liquid container 24 through the capture membrane 28 and into the waste chamber 30 using one of the diaphragm pumps 18.

Elution buffer is pumped and/or drawn through the capture membrane 28 into the homogenization chamber 34, thereby filling the homogenization chamber 34 with a fixed volume of liquid. The liquid contains nucleic acid(s) eluted from capture membrane 28. When the liquid reaches the lyophilized reagent inside the homogenization chamber 34, the lyophilized reagent is reconstituted and a liquid with a defined final concentration is obtained.

The liquid is then distributed to the detection chamber(s) 38 so that a PCR reaction or any other suitable test reaction can take place in the chambers 38.

The above steps are only exemplary steps. Further steps may be possible, such as venting of specific pathways, measuring the pressure inside specific pathways and/or opening and closing valves. Moreover, the above sequence of steps is an exemplary sequence of steps. Different step sequences may be possible depending on the test and analysis to be performed.

Referring to FIG. 2, an exploded view of the exemplary fluidic cartridge 10 of FIG. 1 is shown.

FIG. 2 depicts pre-wet chamber 32 and homogenization chamber 34, the latter is shown in an exploded configuration. Fluidic cartridge 10 includes a first member (lower member) 42, a second member (upper member) 44 and a cover member 46. Cover member 46 is arranged on top of second member 44 and covers second member 44. Pre-wet chamber 32 and homogenization chamber 34 may at least partially be formed within second member 44, but not necessarily.

In the following, the design and function of homogenization chamber 34 will be described in more detail in connection with FIGS. 3 to 5.

Referring to FIG. 3, a schematic section view of homogenization chamber 34 is shown. As already mentioned, homogenization chamber 34 is an example of a fluidic chamber 35 which is used to measure and/or provide a defined volume of liquid for further processing.

Homogenization chamber 34 includes a first fluid compartment 48, a second fluidic compartment 50 and a semipermeable membrane 52 separating first fluid compartment 48 from second fluidic compartment 50. In the exemplary embodiment shown, the first fluid compartment 48 is formed within second member 44 and second fluidic compartment 50 is formed within cover member 46. In addition, cover member 46 is arranged on top of second member 44 such that second fluidic compartment 50 is arranged directly on top of first fluidic compartment 48. More particularly, cover member 46 is arranged such that semipermeable membrane 52 closes a top opening of first fluidic compartment 48 and a bottom opening of second fluidic compartment 50.

Semipermeable membrane 52 is non-permeable (impermeable) for liquid (e.g. polar liquids and/or non-polar liquids, as the case may be) and permeable for air. This means that air can cross semipermeable membrane 52 whereas liquid cannot cross semipermeable membrane 52 as long as a pressure of the liquid is below the breakthrough pressure of semipermeable membrane 52. In the exemplary embodiment shown, the breakthrough pressure of semipermeable membrane 52 may be in the range of at least 20 psi, optionally at least 40 psi, more optionally at least 60 psi. In other embodiments, the breakthrough pressure may be higher.

Semipermeable membrane 52 may be made of PTFE material or any other suitable material.

First fluidic compartment 48 includes a first volume 54. First volume 54 is a predetermined volume. First volume 54 is adjusted such that it is equal to the amount of liquid that needs to be extracted from the fluidic network of fluidic cartridge 10 and used for further processing. First volume 54 may be adjusted by the dimensions of first fluidic compartment 48. First volume 54 may be in the range of 50 microliter to 250 microliter. The person skilled in the art would understand, however, that first volume 54 may be within any other appropriate range as well.

First fluidic compartment 48 includes a conical or funnel-like shape with a diameter increasing towards semipermeable membrane 52. The conical or funnel-like shape ensures that essentially all liquid can be discharged from first fluidic compartment 48 without any or little residual liquid inside first fluidic compartment 48 and/or that essentially no air bubbles are trapped inside first fluidic compartment 48.

Second fluidic compartment 50 includes a second volume 56. Second volume 56 may be in the range of 300 microliter to 500 microliter. The person skilled in the art would understand, however, that second volume 56 may be within any other appropriate range as well. Second fluidic compartment 50 is a closed compartment. That means that second fluidic compartment 50 does not include any air discharge port. In other words, air contained in second fluidic compartment 50 cannot exit second fluidic compartment 50. In yet other words, air contained in second fluidic compartment 50 is trapped inside second fluidic compartment 50. In order to prevent leakage of air from second fluidic compartment 52 to the environment, a sealing element 58 may be provided between second member 44 and cover member 46. In the specific embodiment shown, cover member 46 is clamped onto second member 44 whereby sealing element 58 is compressed so that second fluidic compartment 50 is sealed against the environment. Sealing element 58 may be a separate sealing element and may be made of elastomeric material. In the specific embodiment shown, sealing element 58 is an O-ring. The person skilled in the art would understand, however, that sealing of second fluidic compartment 50 may be achieved in any appropriate way.

First fluidic compartment 48 further includes a reagent 60. In the specific embodiment shown, reagent 60 is a lyophilized reagent and in particular a lyophilized bead. The lyophilized bead may include reagents, in particular PCR reagents such as polymerase, dNTPs and/or enhancers which may be used for PCR test reactions, such as Chlamydia trachomatis and/or Neisseria gonorrhoeae test reactions. Lyophilized bead 60 is reconstituted by the liquid contained inside first fluidic compartment 48. The liquid may be, for example, a liquid eluted from capture membrane 28.

A fluidic supply line 62 is fluidly coupled to first fluidic compartment 48. Fluidic supply line 62 is used for filling first fluidic compartment 48 with liquid. Likewise, a fluid discharge line 64 is fluidly coupled to first fluidic compartment 48. Fluidic discharge line 64 is used for discharging liquid from first fluidic compartment 48.

An inlet valve 66 is located along fluidic supply line 62 and an outlet valve 68 is located along fluidic discharge line 64. Both valves 66, 68 are active valves and are operable between an open state and a closed state. A control unit 70 is operably connected to valves 66, 68 and can operate valves 66, 68 between the open and closed state. The control unit 70 may be part of the fluidic cartridge 10 or may be provided as part of an apparatus (not shown) into which the fluidic cartridge 10 is inserted during use.

A pumping device 72 is fluidly connected to fluidic supply line 62. Pumping device 72 may, for example, be diaphragm pump 18 mentioned earlier. Pumping device 72 is configured for pumping liquid into first fluidic compartment 48 so that first fluidic compartment 48 is filled with liquid.

As can be further seen in FIG. 3, a pressure sensor 74 is operably coupled to fluidic supply line 62. Pressure sensor 74 may be any appropriate pressure sensor which is why no further explanation is given here. In the specific embodiment shown, pressure sensor 74 is arranged between pumping device 72 and inlet valve 66. In other embodiments not shown, pressure sensor 74 may be arranged at any other suitable location. Pressure sensor 74 is configured for sensing a pressure in first fluidic compartment 48 or in second fluidic compartment 50. In the specific embodiment shown, pressure sensor 74 is arranged in fluidic supply line 62 which is why pressure sensor 74 senses the pressure inside first fluidic compartment 48.

Both the pressure sensor 74 and the pumping device 72 are operably connected to control unit 70. Control unit 70 may, for example, receive a pressure signal or data representing the pressure signal from pressure sensor 74, may analyze the signal or data and may perform appropriate actions derived from this analysis. Likewise control unit 70 may, for example, operate pumping device 72 into an active or inactive state.

Referring to FIG. 4, a schematic diagram of a pressure signal 76 provided by pressure sensor 74 is shown. The pressure signal 76 is shown as a function of the degree of filling of first fluidic compartment 48 of homogenization chamber 34. The pressure signal 76 may indicate a relative pressure, which means a pressure above atmospheric pressure. Pressure values of pressure signal 76 may be given in psi, bar or any other appropriate unit.

In the following, it is assumed that outlet valve 68 is in a closed state, inlet valve 66 is in an open state and first fluidic compartment 48 is empty. By the word “empty” is meant that no liquid is present in first fluidic compartment 48.

As long as first fluidic compartment 48 is empty, the pressure sensed by pressure sensor 74 is zero (which means equal to atmospheric pressure). Once pumping device 72 is activated by control unit 70, pumping device 72 pumps liquid into first fluidic compartment 48, whereby air contained in first fluidic compartment 48 is forced through semipermeable membrane 52 and into second fluidic compartment 50. As mentioned, second fluidic compartment 50 is a closed compartment. Thus, air contained in second fluidic compartment 50 is trapped inside second fluidic compartment 50, accumulates in second fluidic compartment 50 and gets compressed. As a result, a pressure inside second fluidic compartment 50 increases. The pressure increase inside second fluidic compartment 50 is sensed as back pressure inside first fluidic compartment 48. Hence, a pressure in first fluidic compartment 48 increases as well. The pressure increases as long as first fluidic compartment 48 is not yet completely filled with liquid. Once, however, the liquid front reaches semipermeable membrane 52, the liquid cannot penetrate semipermeable membrane 52. As a result, the pressure inside second fluidic compartment 50 does no longer increase because there is no more air which is forced through semipermeable membrane 50. As a consequence, the pressure in first fluidic compartment 48 increases more rapidly and/or a rate of change of pressure signal 76 suddenly changes and/or increases. This is schematically shown in FIG. 4 by a first rate of change R1 and a second rate of change R2. As can be seen in FIG. 4, at around 100% fill volume, the rate of change of pressure signal 76 suddenly increases from R1 to R2 which can be used as an indicator that first fluidic compartment 48 is completely filled with liquid. Further operation of pumping device 72 results in a further increase of pressure. As a result, the pressure may approach a predetermined threshold pressure 77. At some point, e.g. when a maximum operation pressure of pumping device 72 is reached, pressure signal 76 may reach a predominantly constant value 78 which can be observed as a plateau 80 in pressure signal 76. A change and/or increase in the rate of change of pressure signal 76, the predetermined threshold pressure 77, the substantially constant value 78 and/or the plateau 80 observed in pressure signal 76 can be used individually or in any combination as an indicator that first fluidic compartment 48 is completely filled with liquid. The predetermined threshold pressure 77 may be any appropriate threshold pressure. Thus, threshold pressure 77 shown in FIG. 4 is only exemplary and shall not limit the scope of this disclosure. For example, threshold pressure 77 may be equal to or below the breakthrough pressure of semipermeable membrane 52. For example, threshold pressure 77 may be in the range of 2 psi to 10 psi, optionally 2 psi to 20 psi, more optionally 2 psi to 40 psi, or even higher.

Once first fluidic compartment 48 is completely filled with liquid, control unit 70 stops the operation of pumping device 72 and closes inlet valve 66. As a result, first fluidic compartment 48 contains a defined volume of liquid which can be used for further processing. Control unit 70 then opens outlet valve 68 and the defined volume of liquid can be discharged via fluidic discharge line 64 into the fluidic network of fluidic cartridge 10 using the pressure inside second fluidic compartment 50.

It will be understood that the graph shown in FIG. 4 is schematic and provided only for the purpose of better illustrating the present invention. For example, the fluid has been assumed to be incompressible and the components of the cartridge 10 have been assumed to show an inelastic behavior for the purposes of this graph. In reality, components of the cartridge 10 such as, e.g., the semipermeable membrane may show some elasticity upon further pumping, i.e. the measured pressure may increase to some extent also in the region of the plateau 80. Moreover, it will be appreciated that pressure measurements may depend on the type of pump device 72 used, e.g. a stepwise increase in pressure may be observed for a diaphragm pump. Also, if pumping is continued in the region of the plateau 80, back pressure spikes may be measured for pump strokes at the pressure sensor 74. These and other effects have been disregarded in FIG. 4 for ease of understanding.

Referring to FIG. 5, a schematic flowchart with exemplary processing steps for transferring liquid into and/or out of first fluidic compartment 48 is shown.

In step 500, pumping device 72 is operated such that first fluidic compartment 48 is filled with liquid whereby air contained in first fluidic compartment 48 is forced through semipermeable membrane 52 and into second fluidic compartment 50. Pumping device 72 is operated while inlet valve 66 is open and outlet valve 68 is closed.

In step 502, operation of pumping device 72 is continued such that the air forced through semipermeable membrane 52 is compressed inside second fluidic compartment 50. As a result, pressure increases.

In step 504, operation of pumping device 72 is stopped when the pressure sensed within first fluidic compartment 48 approaches a predetermined threshold pressure 77 and/or when a rate of change of pressure signal 76 provided by pressure sensor 74 reaches a predetermined value, and/or when the pressure signal 76 does no longer increase and instead reaches a substantially constant value 78.

In step 506, the inlet valve 66 is closed.

In step 508, the outlet valve 68 is opened such that first fluidic compartment 48 is emptied by the pressure inside second fluidic compartment 50.

Steps 500 to 508 may be performed by control unit 70 and may be performed in any suitable sequence.

In the following, the design and function of pre-wet chamber 32 will be described in more detail in connection with FIGS. 6 to 9.

Referring to FIG. 6, an exploded view of pre-wet chamber 32 is shown. As already mentioned, pre-wet chamber 32 is an example of a fluidic chamber 35 which is used to isolate a defined volume of liquid.

Pre-wet chamber 32 includes a first fluidic compartment 82. In the specific embodiment shown, first fluidic compartment 82 is formed as a fluidic pathway 84 arranged in second member 44 of fluidic cartridge 10. However, other shapes than such pathway (e.g., any other type of chamber or compartment) may also be used.

Fluidic pathway 84 may be also referred to as a liquid inlet channel. In the specific embodiment shown, fluidic pathway 84 includes a circular shape but other shapes may be suitable as well. A circular shape helps liquid to be distributed across the semipermeable membrane 88. This way a large area of semipermeable membrane 88 can be subjected to the liquid.

Liquid can enter first fluidic compartment 82 via an inlet opening 86 formed in fluidic pathway 84. Liquid is then guided within fluidic pathway 84 on a, e.g., circular path.

Pre-wet chamber 32 further includes a semipermeable membrane 88. In FIG. 6 semipermeable membrane 88 is shown in an exploded view. Semipermeable membrane 88 has the same function and properties as semipermeable membrane 52 of homogenization chamber 34. Thus, semipermeable membrane 88 is non-permeable (impermeable) for liquid (e.g. polar liquid and/or non-polar liquid, as the case may be) and permeable for air. Semipermeable membrane 88 may be made of the same material and may have the same breakthrough pressure as semipermeable membrane 52 or may be of a different material and/or a different breakthrough pressure.

Referring to FIG. 7, a schematic section view of pre-wet chamber 32 is shown.

FIG. 7 shows semipermeable membrane 88. FIG. 7 also shows first fluid compartment 82 formed as fluidic pathway 84. As can be seen, semipermeable membrane 88 is arranged on top of fluidic pathway 84 and closes fluidic pathway 84 from the top of fluidic pathway 84. Pre-wet chamber 32 further includes a second fluidic compartment 90. Second fluidic compartment 90 is formed in second member 44 of fluidic cartridge 10. Second fluidic compartment 90 is arranged directly on top of first fluidic compartment 82 and separated from first fluidic compartment 82 by semipermeable membrane 88. In the specific embodiment shown, second fluidic compartment 90 is formed as a hole inside second member 44. In other words, in the specific embodiment shown, first and second fluidic compartments 82, 90 are both formed in second member 44, wherein first fluidic compartment 82 is essentially formed as a fluidic pathway or inlet channel leading to second fluidic compartment 90 which is formed as a hole in second member 44.

First fluidic compartment 82 has a first volume 92. First volume 92 is a predetermined volume. First volume 92 is adjusted such that it is equal to the amount of liquid that needs to be isolated from the fluidic network of fluidic cartridge 10. First volume 92 may be in the same range as first volume 54 of homogenization chamber 34, or may be in a different range, depending on the task at hand. First volume 92 can be adjusted by adjusting the shape and/or length of fluidic pathway 84 to the specific task at hand. Fluidic pathway 84 may be an elongated portion of a fluidic pathway present in cartridge 10.

Second fluidic compartment 90 includes a second volume 94. Second volume 94 may be in the same range as second volume 56 of homogenization chamber 34, or may be in a different range, depending on the task at hand. Second fluidic compartment 90 is an open compartment which is a compartment which can communicate with the outside or the environment of second fluidic compartment 90. That means air contained in second fluidic compartment 90 can exit second fluidic compartment 90. This is schematically indicated by arrows with reference numeral 96.

In other words, the second fluidic compartment 90 may be open towards the environment. In yet other words, semipermeable membrane 88 closes first fluidic compartment 82 towards the environment. In yet other words, the semipermeable membrane 88 separates the first fluidic compartment 82 from the environment and/or the semipermeable membrane 88 provides a barrier preventing the fluid in the first fluidic compartment 82 from flowing out of said first fluidic compartment 82 into the environment (while air is allowed to exit into the environment).

A fluidic supply line 98 is fluidly coupled to first fluidic compartment 82. Fluidic supply line 98 is fluidly connected to pumping device 72. Fluidic supply line 98 is used for filling first fluidic compartment 82 with liquid. Liquid can enter first fluidic compartment 82 via inlet opening 86.

In the exemplified pre-wet chamber 32, there is no fluidic discharge line coupled to first fluidic compartment 82. The reason is that pre-wet chamber 32 unlike homogenization chamber 34 primarily functions as a liquid trap. Thus, it is not intended that liquid is discharged from first fluidic compartment 82 which is why no discharge line is necessary. It should be noted, however, that such discharge line may be provided, for example, where the fluid measured and/or provided in the first fluidic compartment 82 is to be used, e.g. for downstream processing.

An inlet valve 100 is located along fluidic supply line 98. Inlet valve 100 is an active valve and operable between an open state and a closed state. Control unit 70 is operably connected to valve 100 and can operate valve 100 between the open and closed state.

As can be further seen in FIG. 7, a pressure sensor 102 is operably coupled to fluidic supply line 98. In the specific embodiment shown, pressure sensor 102 is arranged between pumping device 72 and inlet valve 100. In other embodiments not shown, pressure sensor 102 may be arranged at any other suitable location. Pressure sensor 102 is configured for sensing a pressure in first fluidic compartment 82. Pressure sensor 102 and pressure sensor 74 may be the same pressure sensor or may be different pressure sensors.

Pressure sensor 102 is operably connected to control unit 70. Control unit 70 may, for example, receive a pressure signal or data representing the pressure signal from pressure sensor 102, may analyze the signal or data and may perform appropriate actions derived from this analysis.

Referring to FIG. 8, a schematic diagram of a pressure signal 104 provided by pressure sensor 100 is shown. The pressure signal 104 is shown as a function of the degree of filling of first fluidic compartment 82 of pre-wet chamber 32. The pressure signal 104 may indicate a relative pressure, which means a pressure above atmospheric pressure. Pressure values of pressure signal 104 may be given in psi, bar or any other appropriate unit.

In the following it is assumed that inlet valve 100 is in an open state and first fluidic compartment 82 is empty. By the word “empty” is meant that no liquid is present in first fluidic compartment 82.

As long as first fluidic compartment 82 is empty, the pressure sensed by pressure sensor 100 may be zero (meaning equal to atmospheric pressure). Once pumping device 72 is activated by control unit 70, pumping device 72 pumps liquid into first fluidic compartment 82, whereby air contained in first fluidic compartment 82 is forced through semipermeable membrane 88 into second fluidic compartment 90. As mentioned, second fluidic compartment 90 is an open compartment. Thus, air contained in second fluidic compartment 90 may exit or leave second fluidic compartment 90. As a result, a pressure inside second fluidic compartment 90 and thus also a pressure in first fluidic compartment 82 does not increase until the liquid front reaches semipermeable membrane 88. Once, the liquid front reaches semipermeable membrane 88, the liquid cannot penetrate semipermeable membrane 88. As a result, the pressure inside first fluidic compartment 88 rapidly increases and/or a rate of change of pressure signal 104 suddenly changes and/or increases. As long as the pressure of the liquid is below the breakthrough pressure of semipermeable membrane 88, the pressure inside first fluidic compartment 82 cannot increase any further because of the impermeability of semipermeable membrane 88. As a consequence, the pressure approaches a predetermined threshold pressure 105 and/or the pressure signal 104 reaches a predominantly constant value 106 which can be observed as a plateau 108 in pressure signal 104. The predetermined threshold pressure 105 may be any appropriate threshold pressure. Thus, threshold pressure 105 shown in FIG. 8 is only exemplary and shall not limit the scope of this disclosure. For example, predetermined threshold pressure 105 may be equal to or below the breakthrough pressure of semipermeable membrane 88. For example, predetermined threshold pressure 105 may be in the range of 2 psi to 10 psi, optionally 2 psi to 20 psi, more optionally 2 psi to 30 psi, or higher. A change and/or increase in a rate of change of pressure signal 104, the predetermined threshold pressure 105, the substantially constant value 106 and/or the plateau 108 observed in pressure signal 104 can be used individually or in any combination as an indicator that first fluidic compartment 82 is completely filled with liquid.

Once first fluidic compartment 82 is completely filled with liquid, control unit 70 may stop the operation of pumping device 72 and close inlet valve 100. The first fluidic compartment 88 is filled with a predefined volume of liquid. The predefined volume of liquid is “trapped” and isolated from the fluidic network of fluidic cartridge 10.

Again, it will be understood that the graph shown in FIG. 8 is schematic and provided only for the purpose of better illustrating the present invention. For example, the fluid has been assumed to be incompressible and the components of the cartridge 10 have been assumed to show an inelastic behavior for the purposes of this graph. In reality, components of the cartridge 10 such as, e.g., the semipermeable membrane 88 may show some elasticity upon further pumping, i.e. the measured pressure may increase to some extent also in the region of the plateau 80. Moreover, it will be appreciated that pressure measurements may depend on the type of pump device 72 used, e.g. a stepwise increase in pressure may be observed for a diaphragm pump. Also, if pumping is continued in the region of the plateau 80, back pressure spikes may be measured for pump strokes at the pressure sensor 102. These and other effects have been disregarded in FIG. 8 for ease of understanding.

Referring now to FIG. 9, a schematic flowchart is shown with exemplary processing steps for transferring liquid into first fluidic compartment 82.

In step 900, pumping device 72 is operated such that first fluidic compartment 82 is filled with liquid whereby air contained in first fluidic compartment 82 is forced through semipermeable membrane 88 into second fluidic compartment 90. Pumping device 72 is operated while inlet valve 100 is open. During operation of pumping device 72, first fluidic compartment 82 is filled with liquid until the liquid front reaches semipermeable membrane 88 which results in a sudden pressure increase.

In step 902, operation of pumping device 72 is stopped when the pressure sensed within first fluidic compartment 82 approaches a predetermined threshold pressure 105, and/or when a rate of change of pressure signal 104 provided by pressure sensor 102 reaches a predetermined value, and/or when the pressure signal 104 does no longer increase and instead reaches a substantially constant value 106.

In step 904, inlet valve 100 is closed. As a result, the predefined volume of liquid is isolated from the fluidic network of fluidic cartridge 10.

Steps 900 to 904 may be performed by control unit 70 and may be performed in any suitable sequence.

The person skilled in the art will understand that any processing steps explained in connection with FIGS. 5 to 9 may be combined with any processing steps explained in connection with FIGS. 3 to 5.

In the following, one example of such combination of processing steps is explained in connection with FIGS. 1 to 9.

To begin with, control unit 70 may close inlet and outlet valve 66, 68 of homogenization chamber and may open inlet valve 100 of pre-wet chamber 32.

Next, control unit 70 may operate pumping device 72 such that first fluidic compartment 82 of pre-wet chamber 32 is filled with liquid, for example elution buffer. As a result, any remaining air and/or residual liquid inside pores of capture membrane 28 is pushed into pre-wet chamber 32. Air is forced through semipermeable membrane 88 into second fluidic compartment 90 where it leaves second fluidic compartment 90. Control unit 70 may operate pumping device 72 until the pressure signal of pressure sensor 102 indicates that first fluidic compartment 82 is completely filled with liquid.

Next, control unit 70 may close inlet valve 100 of pre-wet chamber 32. Liquid contained inside first fluidic compartment 82 is trapped and any carry-over of liquid from pre-wet chamber 32 to homogenization chamber 34 is prevented. The line up to capture membrane 28 is now primed for further action.

Next, control unit 70 may open inlet valve 66 of homogenization chamber 34. First fluidic compartment 48 of homogenization chamber 34 can be filled with liquid eluted from capture membrane 28. Control unit 70 may operate pumping device 72 until the pressure signal of pressure sensor 74 indicates that first fluidic compartment of 48 of homogenization chamber 34 is completely filled.

Next, control unit 70 may close inlet valve 66 of homogenization chamber 34. First fluidic compartment 48 is now completely filled with a defined volume of liquid that has been eluted from capture membrane 28. Reagent 60 is reconstituted by the eluted liquid inside first fluidic compartment 48. A liquid with a defined final concentration is obtained. Such defined concentration is of high relevance for certain tests and/or amplification methods. It may be measured and/or provided as described herein in a repeatable, robust and simple manner, i.e. without the need for stroke controlled pumping devices and/or flow rate measurements.

Next, control unit 70 may open outlet valve 68 so that the liquid with the defined final concentration can be transferred, for example to analyte detection section 40 for further processing.

The person skilled in the art would understand that other appropriate processing steps and/or other sequences of processing steps may be possible, depending on the specific task at hand.

The person skilled in the art will understand that pressure signals 77, 104 may be processed, filtered and/or conditioned by any suitable means known to a person skilled in the art. Processing, filtering and/or conditioning may be done prior to analyzing pressure signals 77, 104, e.g. for establishing whether first fluidic compartment 48, 82 is completely filled with liquid. The person skilled in the art would understand, however, that any processing, filtering and/or conditioning of pressure signals 74, 102 is only optional.

The skilled person will be capable of modifying the exemplary fluidic cartridge to implement the inventive aspects described herein in various ways depending on the circumstances at hand. It is intended that the scope of the present invention is defined solely by the following claims and their equivalents.

The following aspects are preferred embodiments of the invention:
1. A fluidic cartridge (10), comprising:
   a fluidic chamber (32, 34, 35) including
      a first fluidic compartment (48, 82), and
   a semipermeable membrane (52, 88),
      wherein the semipermeable membrane (52, 88) separates the first fluidic compartment (48, 82) from a second fluidic compartment (50, 90) of the fluidic chamber (32, 34, 35) and/or wherein the semipermeable membrane (52, 88) closes the first fluidic compartment (48, 82) against an environment of the fluidic cartridge (10), and
      wherein the semipermeable membrane (52, 88) is non-permeable for liquid and permeable for air, and
   a pumping device (72) configured for pumping a liquid into the first fluidic compartment (48, 82) such that the first fluidic compartment (48, 82) is filled with the liquid, whereby air contained in the first fluidic compartment (48, 82) is forced through the semipermeable membrane (52, 88) into the second fluidic compartment (50, 90) and/or into the environment.
2. The fluidic cartridge (10) of aspect 1, wherein the first fluidic compartment (48, 82) includes a first volume (54, 92), optionally wherein the first volume (54, 92) is a predetermined volume.
3. The fluidic cartridge (10) of any one of aspects 1-2, wherein the second fluidic compartment (90) is a closed compartment configured for accumulating the air.
4. The fluidic cartridge (10) of any of aspects 1-3, wherein the second fluidic compartment (50, 90) is arranged on top of the first fluidic compartment (48, 82), optionally wherein the second fluidic compartment (50, 90) is arranged directly on top of the first fluidic compartment (48, 82), more optionally wherein the semipermeable membrane (52, 88) closes a top opening of the first fluidic compartment (48, 82) and a bottom opening of the second fluidic compartment (50, 90).
5. The fluidic cartridge (10) of any of aspects 1-4, further comprising:
   a pressure sensor (74, 102) configured for sensing a pressure in the first fluidic compartment (48, 82) and/or in the second fluidic compartment (50, 90).
6. The fluidic cartridge (10) of aspect 5, further comprising:
   a control unit (70) configured for controlling the pumping device (72) into an inactive state when the pressure sensed by the pressure sensor (74, 102) approaches a predetermined threshold pressure (77, 105), and/or when a rate of change of a pressure signal (76, 104) provided by the pressure sensor (74, 102) reaches a predetermined threshold value, and/or when a pressure signal (76, 104) provided by the pressure sensor (74, 102) reaches a substantially constant value (78, 106).
7. The fluidic cartridge (10) of aspect 6, wherein the threshold pressure (77, 105) is equal to or below a breakthrough pressure of the semipermeable membrane (52, 88).
8. The fluidic cartridge (10) of any one of aspects 1-7, further comprising:
   a fluidic supply line (62, 98) coupled to the first fluidic compartment (48, 82) and configured for supplying the liquid to the first fluidic compartment (48, 82).
9. The fluidic cartridge (10) of aspect 8 in combination with any one of aspects 5-7, wherein the pressure sensor (74, 102) is located in the fluidic supply line (62, 98).
10. The fluidic cartridge (10) of any one of aspects 8-9, further comprising:
   an inlet valve (66, 100) located in the fluidic supply line (62, 98) and operable between an open state and a closed state.
11. The fluidic cartridge (10) of any one of aspects 1-10, further comprising:
   a fluidic discharge line (64) coupled to the first fluidic compartment (48, 82) and configured for discharging the first fluidic compartment (48, 82).
12. The fluidic cartridge (10) of aspect 11, further comprising:
   an outlet valve (68) located in the fluidic discharge line (64) and operable between an open state and a closed state.
13. The fluidic cartridge (10) of any one of aspects 1-12, further comprising:
   a reagent (60) configured to be reconstituted, optionally a lyophilized reagent, more optionally a lyophilized bead, located in the first fluidic compartment (48, 82) and configured for being reconstituted by the liquid in the first fluidic compartment (48, 82).
14. The fluidic cartridge (10) of any one of aspects 1-13, wherein the first fluidic compartment (48) has a conical shape and/or a funnel-like shape and/or a tapered shape, optionally with a diameter and/or width increasing towards the semipermeable membrane (52).
15. A method of transferring liquid into and/or out of a fluidic chamber of a fluidic cartridge (10), the fluidic chamber (32, 34, 35) including
   a first fluidic compartment (48, 82) and
   a semipermeable membrane (52, 88),
      wherein the semipermeable membrane (52, 88) separates the first fluidic compartment (48, 82) from a second fluidic compartment (50, 90) of the fluidic chamber (32, 34, 35) and/or wherein the semipermeable membrane (52, 88) closes the first fluidic compartment (48, 82) against an environment of the fluidic cartridge (10),
      wherein the semipermeable membrane (52, 88) is non-permeable for liquid and permeable for air,
wherein the method comprises the step of:
   operating a pumping device (72) such that the first fluidic compartment (48, 82) is filled with a liquid, whereby air contained in the first fluidic compartment (48, 82) is forced through the semipermeable membrane (52, 88) into the second fluidic compartment (50, 90) and/or into the environment.
16. The method of aspect 15, further comprising the step of:
   continuing operation of the pumping device (72) such that the air forced through the semipermeable membrane (52) is compressed in the second fluidic compartment (50).
17. The method of any one of aspects 15-16, wherein operation of the pumping device (72) is stopped, when
   a pressure sensed within the first or the second fluidic compartment (50, 90) approaches a predetermined threshold pressure (77, 105), and/or
   a rate of change of a pressure signal (76, 104) provided by the pressure sensor (74, 102) reaches a predetermined threshold value, and/or
   a pressure signal (76, 104) provided by the pressure sensor (74, 102) reaches a substantially constant value (78, 106).
18. The method of aspect 17, wherein the predetermined threshold pressure (77, 105) is equal to or below a breakthrough pressure of the semipermeable membrane (52, 88).
19. The method of any one of aspects 17-18, further comprising:
   operating the pumping device (72) while an inlet valve (66) located in a fluidic supply line (62) coupled to the first fluidic compartment (48) is in an open state and an outlet valve (68) located in a fluidic discharge line (64) coupled to first fluidic compartment (48) is in a closed state,
   stop operating the pumping device (72) when the pressure sensed within the first or second fluidic compartment (50) approaches the predetermined threshold pressure (77) and/or when the pressure signal (76) provided by the pressure sensor (74) reaches the substantially constant value (78).
20. The method of aspect 19, further comprising:
   closing the inlet valve (66) such that the fluidic supply line (62) is closed.
21. The method of aspect 20, further comprising:
   opening the outlet valve (68) such that the first fluidic compartment (48) is emptied by the pressure in the second fluidic compartment (50).

1. A fluidic cartridge (10), comprising:
a fluidic chamber including
a first fluidic compartment and
a semipermeable membrane,
wherein the semipermeable membrane separates the first fluidic compartment from a second fluidic compartment of the fluidic chamber,
wherein the semipermeable membrane is non-permeable for liquid and permeable for air, and
wherein the second fluidic compartment is a closed compartment configured for accumulating air,
a pumping device configured for pumping a liquid into the first fluidic compartment such that the first fluidic compartment is filled with the liquid, whereby air contained in the first fluidic compartment is forced through the semipermeable membrane into the second fluidic compartment and accumulates in the second fluidic compartment such that a pressure within the second fluidic compartment increases, and
a fluidic discharge line coupled to the first fluidic compartment and configured for discharging the first fluidic compartment using the pressure within the second fluidic compartment.

2. The fluidic cartridge of claim 1, wherein the first fluidic compartment includes a first volume preferably wherein the first volume is a predetermined volume.

3. The fluidic cartridge of claim 1, wherein the second fluidic compartment is arranged on top of the first fluidic compartment

4. The fluidic cartridge of claim 1, further comprising:
a pressure sensor configured for sensing a pressure in at least one of the first fluidic compartment and in the second fluidic compartment.

5. The fluidic cartridge of claim 4, further comprising:
a control unit configured for controlling the pumping device into an inactive state when at least one of
the pressure sensed by the pressure sensor approaches a predetermined threshold pressure,
a rate of change of a pressure signal provided by the pressure sensor reaches a predetermined threshold value, and
a pressure signal provided by the pressure sensor reaches a substantially constant value.

6. The fluidic cartridge of claim 5, wherein the threshold pressure is equal to or below a breakthrough pressure of the semipermeable membrane.

7. The fluidic cartridge of claim 1, further comprising:
a fluidic supply line coupled to the first fluidic compartment and configured for supplying the liquid to the first fluidic compartment.

8. The fluidic cartridge of claim 7, further comprising a pressure sensor configured for sensing a pressure in at least one of the first fluidic compartment and the second fluidic compartment, wherein the pressure sensor is located in the fluidic supply line.

9. The fluidic cartridge of claim 1, further comprising:
an outlet valve located in the fluidic discharge line and operable between an open state and a closed state.

10. The fluidic cartridge of claim 1, further comprising:
a reagent located in the first fluidic compartment and configured for being reconstituted by the liquid in the first fluidic compartment.

11. The fluidic cartridge of claim 1, wherein the first fluidic compartment has at least one of a conical shape, a funnel-like shape and a tapered shape.

12. A method of transferring liquid into a fluidic chamber of a fluidic cartridge, the fluidic cartridge comprising;
a fluidic chamber including
a first fluidic compartment, and
a semipermeable membrane,
wherein the semipermeable membrane separates the first fluidic compartment from a second fluidic compartment of the fluidic chamber,
wherein the semipermeable membrane is non-permeable for liquid and permeable for air, and
wherein the second fluidic compartment is a closed compartment configured for accumulating air,
a pumping device configured for pumping a liquid into the first fluidic compartment such that the first fluidic compartment is filled with the liquid, whereby air contained in the first fluidic compartment is forced through the semipermeable membrane into the second fluidic compartment and accumulates in the second fluidic compartment such that a pressure within the second fluidic compartment increases, and
a fluidic discharge line coupled to the first fluidic compartment and configured for discharging the first fluidic compartment using the pressure within the second fluidic compartment,
wherein the method comprises the step of:
operating the pumping device such that the first fluidic compartment is filled with a liquid, whereby air contained in the first fluidic compartment is forced through the semipermeable membrane into the second fluidic compartment.

13. The method of claim 12, wherein operation of the pumping device is stopped, when at least one of
a pressure sensed within at least one of the first and the second fluidic compartment approaches a predetermined threshold pressure,
a rate of change of a pressure signal provided by a pressure sensor reaches a predetermined threshold value, and
a pressure signal provided by a pressure sensor reaches a substantially constant value.

14. The method of claim 13, further comprising:
operating the pumping device while an inlet valve located in a fluidic supply line coupled to the first fluidic compartment is in an open state and an outlet valve located in a fluidic discharge line coupled to first fluidic compartment is in a closed state,
stop operating the pumping device when the pressure sensed within the first or second fluidic compartment approaches the predetermined threshold pressure,
closing the inlet valve such that the fluidic supply line is closed, and
opening the outlet valve such that the first fluidic compartment is emptied by the pressure in the second fluidic compartment.

15. The fluidic cartridge of claim 1, wherein the second fluidic compartment is arranged directly on top of the first fluidic compartment.

16. The fluidic cartridge of claim 1, wherein the semipermeable membrane closes a top opening of the first fluidic compartment and a bottom opening of the second fluidic compartment.

17. The fluidic cartridge of claim 1, further comprising:
an inlet valve located in the fluidic supply line and operable between an open state and a closed state.

18. The fluidic cartridge of claim 10, wherein the reagent is a lyophilized bead.

19. The fluidic cartridge of claim 11, wherein at least one of a diameter and a width of the first fluidic compartment increases toward the semipermeable membrane.

20. The method of claim 13, further comprising:
operating the pumping device while an inlet valve located in a fluidic supply line coupled to the first fluidic compartment is in an open state and an outlet valve located in a fluidic discharge line coupled to first fluidic compartment is in a closed state,
stop operating the pumping device when the pressure signal provided by the pressure sensor reaches the substantially constant value,
closing the inlet valve such that the fluidic supply line is closed, and
opening the outlet valve such that the first fluidic compartment is emptied by the pressure in the second fluidic compartment.
